(19) United States
(12) Patent Application Publication
(10) Pub. No.: US 2017/0200236 A1
(43) Pub. Date: Jul. 13, 2017

(54) MULTI-CHANNEL-NETWORK MANAGEMENT SYSTEM

(71) Applicant: ZYX Integrated Technologies, Inc., Austin, TX (US)

(72) Inventors: Dante Carmelo Cullari, Austin, TX (US); Mark Gregory Valente, Austin, TX (US)

(21) Appl. No.: 14/990,704

(22) Filed: Jan. 7, 2016

(51) Int. Cl. G06Q 50/00; G06Q 30/02

(52) U.S. Cl. CPC G06Q 50/01; G06Q 30/0214

(57) ABSTRACT

Described herein are technologies related to an implementation of a content management system that accesses multiple providers of products, services and/or content. The products, services and/or content are associated with particular entities. Actions performed by users are identified as to particular products, services and/or content. Users are rewarded for the actions, and the entities are credited.

### BACKGROUND

Internet commerce involves many different parties, including service and product providers, online customers and clients, intermediary parties, parties associated with products/services, etc. Various products and services may be provided by different businesses, individuals, and other entities. Competition for customers and clients is important for such providers of products and services. Marketing to customers of products and services, including developing customer interest can be crucial for online providers.

In many instances, different services and products may be marketed, sold, or made available by a number of providers. A single provider may support various entities, such as individuals, and services and products associated with such entities. The single provider may initiate a campaign to promote various services and products that are associated with different entities. It is expected that certain services and products may receive greater attention or interest by customers or clients than other services and products that are part of the same campaign.

Entities (e.g., individuals) that provide products and services to providers, rely on such providers to effectively create customer interest, and also expect to be sufficiently rewarded for the products and services that are associated with such entities/individuals.

Customers or clients may also be asked to perform an action or comment on available products and services. Such customer actions may be rewarded.

### BRIEF DESCRIPTION OF THE DRAWINGS

FIG. 1 illustrates an example multi-channel content management system.

FIG. 2 illustrates an example scenario of a example multi-channel content management system implementing call to action modules.

FIG. 3 illustrates an exemplary process for implementing a multi-channel content management system that implements call to action association with users and products, services and content.

FIG. 4 illustrates an exemplary computer system 400 that implements the processes and techniques described herein.

### DETAILED DESCRIPTION

Described herein are technologies for implementing a multi-channel content management system that implements call to action of users, associating such call to action with products, services, and content. Users may be rewarded for such call to action. Particular products, services, and content may be associated with particular entities, such as individual persons. In an example scenario, a marketing campaign may be initiated to promote various products, services, and content. User interest through call to action associated with specific products, services and content may be credited to the particular entities associated with such products, services and content.

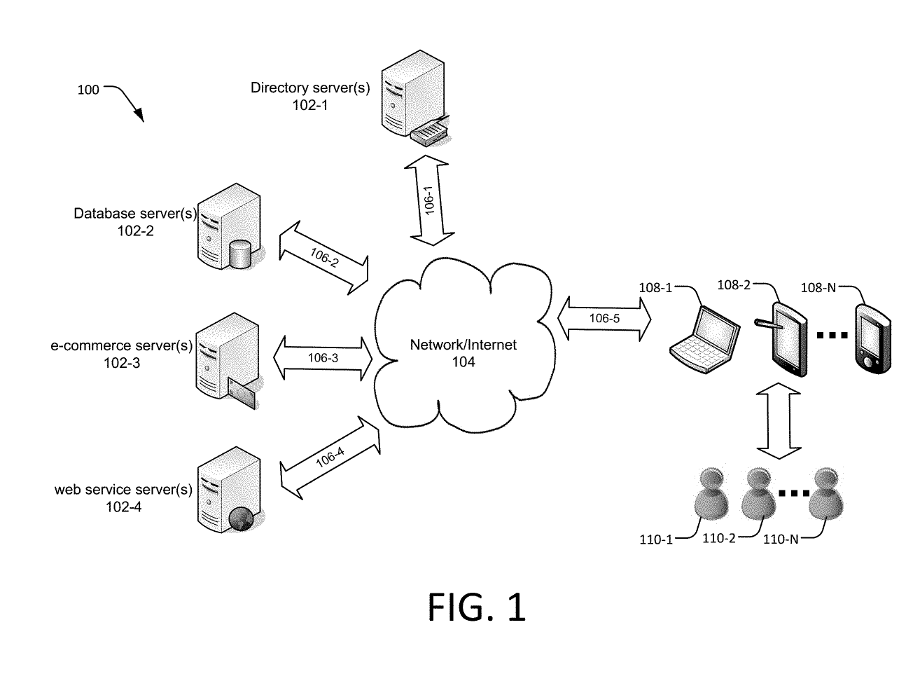

FIG. 1 is a multi-channel content management system 100. The system 100 may include various servers and cloud based services, as represented by servers 102. Shown as an example, but not limited to, are representative directory server(s) 102-1, database server(s) 102-2, e-commerce server(s) 102-3, and web service server(s) 102-4. It is to be understood that servers 102 may be implemented in various configurations, including combined functionality, multiple device/server, and cloud base. In certain scenarios, other types of servers or computing devices may be implemented.

In certain scenarios, multiple providers distribute and various products, services and content. Examples of products, services and content include and are not limited to physical merchandise (e.g., clothing), music, software applications, etc. In particular instances, a general marketing campaign may involve products, services and content associated with different entities, such as individual persons. One of more of the servers 102 may be used in associating user actions (i.e., call to action) with particular products, services and content, and crediting the entities associated with such products, services and content.

As described herein, servers 102 may be used to provide products, services and content. The servers 102 may implement call to action processes that allow users to perform acts associated with such products, services and content. Servers 102 may associate such user call to action with particular products, services and content, and relate specific products, services and content to specific entities, such as individual persons or providers.

The servers 102 may be connected to a network 104, such as the Internet, which connects to the World Wide Web. The connections are represented by multi-channel connections 106. The multi-channels 106 includes connections or multi-channels 106-5 to various devices 108-1, 108-2 and 108-N. Multi-channels 106-5 may include application program interfaces (API). The devices 108 include, but are not limited to computing devices such as laptops, desktops, tablets, cell phones, etc. The devices 108 may be associated to various users 110. It is to be understood that the users 110 may be associated with one or more devices 108.

The users 110 may be particularly identified through one or more accounts, identifiers, etc. For example, users 110 access and use a social network such the Facebook™ network, Twitter™ network, etc. Users may be identified through unique network parameters such as IP address, and in certain implementations, users 110 agree to provide or be tracked in providing certain information. Servers 102 may include administration and tracking of such user information, and include call to action as implemented by users 110.

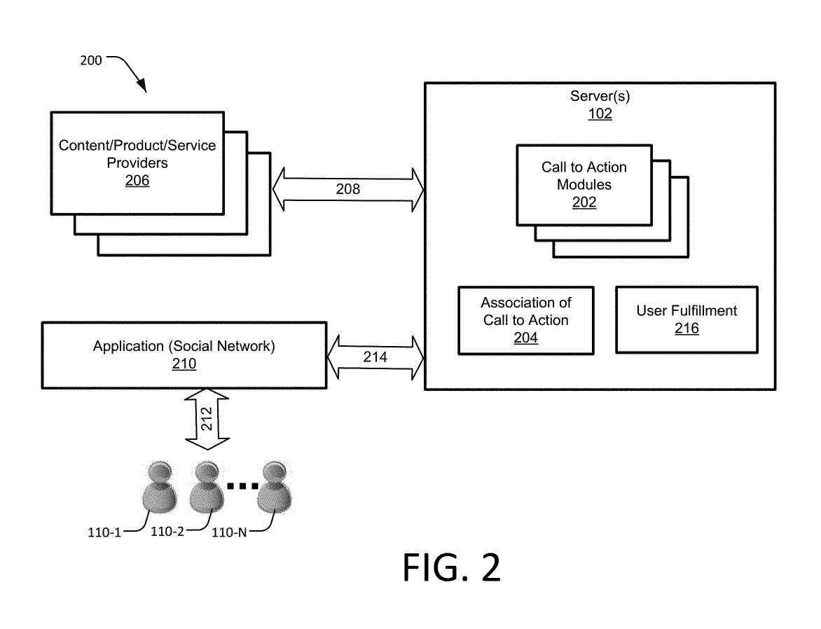

FIG. 2 is a multi-channel content management system 200 implementing call to action modules. One or more servers 102, or a cloud based system, or other implementations, may include call to action modules 202. The call to action modules 202 allow users 110 to perform an act that may associate particular products, services, and content to the act.

Examples of call to action modules 202, include modules related to products, services, and content, related to “liking”, “commenting”, “subscribing to” and customized modules tailored to particular entities and products, services and content. Call to action modules may be connected to one another, and include other call to action modules that relate product, services and content to acts performed by users 110. For example, a user act, which may be performed by a call to action module, may relate to “downloading”, “discounting” or “giving away” a product, service, and/or content. Such acts may be considered as “rewards” to users 110 for performing an action (call to action). In certain implementations, the reward may be selected (pre-selected) by a user 110 and automatically provided when a user 110 performs an action.

In this example, another module(s) 204 may be implemented to associate users 110 with call to action modules 202 or acts that are performed through call to action modules 202.

Multiple providers or entities of product, services and content are represented by content/product/service providers 206. The entities may be identified or related to the product, services and content that they provide. Server(s) 102 in the example scenario may track or relate entities with product, services and content. Product, services and content may be received through other servers and websites. Examples of websites include Youtube™ video sharing site, Soundcloud™ music site, Facebook™ photo albums, website stores, etc. Connection between server(s) 102 to content/product/service providers 206 may be performed through multi channels, as represented by connection 208.

Users 110 may implement an application(s) or go through particular sites, such as social networking sites, as represented by application (social network) 210. In particular, users 110 implement devices 108 that either access or implement application (social network) 210. Connection or device implementation is represented by connection 212.

Connection to server(s) 102 from application (social network) 210 is represented by connection 214 which may be a multi-channel connection. As discussed above, application program interfaces (API) may be provided at devices to connect or interact with servers(s) 102. In certain implementations, an automated user fulfillment module 216 is implemented within server(s) 102. 102. The automated user fulfillment module 216 may provide rewards associated with user 110 actions (call to action). For example, if a user comments, buys, etc. (e.g., perform a call to action) as to particular products, services and/or content, a reward is associated with such actions (call to action).

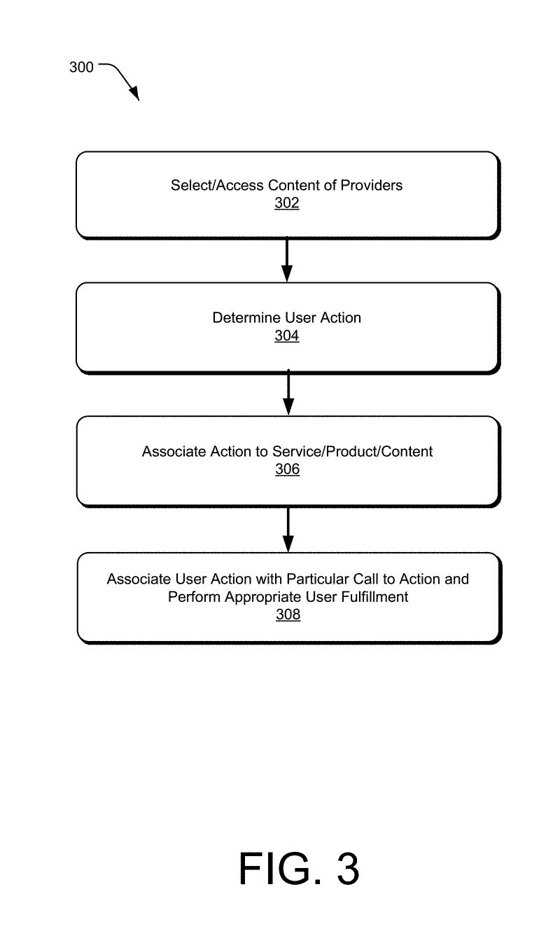

FIG. 3 shows an example process flowchart 300 illustrating an example method for implementing a multi-channel content management system that implements call to action association with users and products, services and content. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 302, accessing content, products and/or services from providers is performed. The accessing may include selecting particular products, services and content from various locations (e.g., websites). Products, services and content may be related to specific entities, such as individuals or companies.

At block 304, determining a call to action is performed. A call to action may be an act performed by a user as directed to particular products, services and content. The call to action may also be related to other call to actions. For example, a user performs an act (as related to a call to action), and another action is performed in relation to the user act (e.g., rewarding the user for purchasing a product, service and/or content).

At block 306, associating the call to action to a product(s), service(s) and/or content is performed. The associating may include identifying particular entities that are associated with the product(s), service(s) and/or content. As an example implementation, the associating and identifying to particular entities may allow such entities to receive proper credit when a multi-product, multi-service, multi-content marketing campaign is conducted.

At block 308, performing user fulfillment is conducted. Associating user actions to particular call to action is also performed. Based on a user(s)'s actions, (e.g., perform a call to action) as to particular products, services and/or content, a reward is associated with such actions (call to action).

The approaches and systems described herein may be deployed in part or in whole through a machine that executes computer software, program codes, and/or instructions on one or more processors contained in the client devices and/or the server or servers associated with the web-based storage system.

Implementations of the disclosure may include a method on a machine, a system or apparatus as part of or in relation to the machine, or a computer program product embodied in a computer readable medium executing on one or more of the machines. The one or more processors may be part of a server, client, network infrastructure, mobile computing platform, stationary computing platform, or other computing platform.

A processor may be any kind of computational or processing device capable of executing program instructions, codes, binary instructions and the like. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

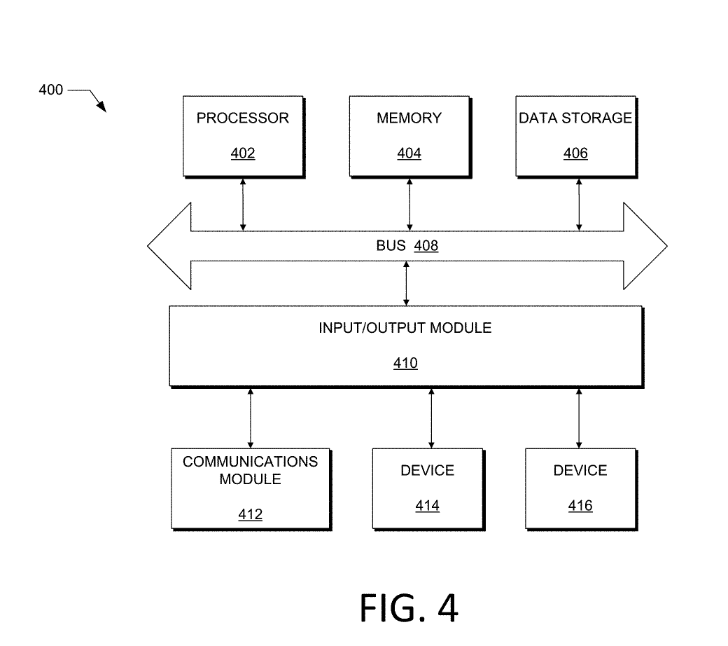

FIG. 4 is a block diagram illustrating an exemplary computer system 400 with which the multi-channel content management system of FIG. 1 may implement the scenario of a implementing call to action modules of FIG. 2 and the process of FIG. 3. In certain aspects, the computer system 400 may be implemented using hardware or a combination of software and hardware, either in a dedicated server, or integrated into another entity, or distributed across multiple entities.

Computer system 400 includes a bus 408 or other communication mechanism for communicating information, and a processor 402 coupled with bus 408 for processing information. By way of example, the computer system 400 may be implemented with one or more processors 402.

Computer system 400 can include, in addition to hardware, code that creates an execution environment for the computer program in question, e.g., code that constitutes processor firmware, a protocol stack, a database management system, an operating system, or a combination of one or more of them stored in an included memory 404, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, logic circuitry.

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more location without deviating from the scope of the disclosed subject matter. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RANI, ROM and the like. The processes, methods, program codes, instructions described herein and elsewhere may be executed by one or more of the network infrastructural elements.

The computer software, program codes, and/or instructions may be stored and/or accessed on machine readable media that may include: computer components, devices, and recording media that retain digital data used for computing for some interval of time; semiconductor storage known as random access memory (RANI); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RANI disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The elements described and depicted herein, including in flow charts and block diagrams throughout the figures, imply logical boundaries between the elements. However, according to software or hardware engineering practices, the depicted elements and the functions thereof may be implemented on machines through non-transitory computer executable media having a processor capable of executing program instructions stored thereon as a monolithic software structure, as standalone software modules, or as modules that employ external routines, code, services, and so forth, or any combination of these, and all such implementations may be within the scope of the present disclosure.

Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various techniques identified and described above may be varied, and that the order of techniques may be adapted to particular applications of the techniques disclosed herein. All such variations and modifications are intended to fall within the scope of this disclosure. As such, the depiction and/or description of an order for various techniques should not be understood to require a particular order of execution for those techniques, unless required by a particular application, or explicitly stated or otherwise clear from the context.

The methods and/or processes described above, and techniques thereof, may be realized in hardware, or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The instructions may be stored in the memory 404 and implemented in one or more computer program products, i.e., one or more modules of computer program instructions encoded on a computer readable medium for execution by, or to control the operation of, the service 100, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python).

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via an input/output module 410 to various devices. The input/output module 410 can be any input/output module. Example input/output modules 410 include data ports such as USB ports. The input/output module 410 is configured to connect to a communications module 412. Example communications modules 412 include networking interface cards, such as Ethernet cards and modems. In certain aspects, the input/output module 410 is configured to connect to a plurality of devices, such as an input device 414 and/or an output device 416. Example input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 416 include display devices, such as a CRT (cathode ray tube) or LCD (liquid crystal display) monitor, for displaying information to the user.

According to one aspect of the present disclosure, the system for associating a file type with an application as shown in FIGS. 1-2, can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the processes described herein. One or more processors in a multi-processing arrangement may also be employed to execute the sequences of instructions contained in memory 404. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a personal area network (PAN), a local area network (LAN), a campus area network (CAN), a metropolitan area network (MAN), a wide area network (WAN), a broadband network (BBN), the Internet, and the like. Further, the communication networks can include, but are not limited to, for example, any one or more of the following network topologies, including a bus network, a star network, a ring network, a mesh network, a star-bus network, tree or hierarchical network, or the like. The communications modules can be, for example, modems or Ethernet cards.

As discussed above, computing system 400 can include clients and servers. A client and server are generally remote from each other and typically interact through a communication network. The relationship of client and server arises by virtue of computer programs running on the respective computers and having a client-server relationship to each other. Computer system 400 can be, for example, and without limitation, an enterprise server or group of servers, one or more desktop computers, one or more laptop computers, etc. Computer system 400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 402 for execution. Such a medium may take many forms, including, but not limited to, non-volatile media, volatile media, and transmission media. Non-volatile media include, for example, optical or magnetic disks, such as data storage device 406. Volatile media include dynamic memory, such as memory 404. Transmission media include coaxial cables, copper wire, and fiber optics, including the wires that comprise bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

In the claims appended herein, the inventors invoke 35 U.S.C. §112, paragraph 6 only when the words “means for” or “steps for” are used in the claim. If such words are not used in a claim, then the inventors do not intend for the claim to be construed to cover the corresponding structure, material, or acts described herein (and equivalents thereof) in accordance with 35 U.S.C. §112, paragraph 6.

The following examples pertain to further embodiments:

Example 1 is a content management system comprising: one or more servers accessing multiple providers comprising a plurality of products, services and/or content, and interfacing with multiple users, wherein the one or more servers comprise: call to action modules that associate user action to the multiple providers and the products, services and/or content; a module that associates the multiple users with actions as performed through the call to action modules; and a automatic user fulfillment module that relates rewards to actions performed. C

In example 2, the content management system of example 1, wherein the multiple providers comprise multiple parties providing the plurality of products, services and/or content, wherein particular entities provide particular products, services and/or content.

In example 3, the content management system of example 2, wherein the call to action modules identify actions associated with the particular entities of the multiple entities.

In example 4, the content management system of example 2, wherein the particular entities are identified by the products, services and/or content that they provide.

In example 5, the content management system of example 2, wherein the particular entities are identified when a call to action is performed as related to products, services and/or content of the particular entities.

In example 6, the content management system of example 1, wherein the multiple users are identified individually by unique user identifiers.

In example 7, the content management system of example 1, wherein the multiple users are rewarded when a transaction is performed using one or more of the call to action modules.

Example 8 is a computing device supporting a content management system comprising: one or more processors; and memory accessed by the one or more processors configured to: associate a products, services and content to particular entities; associate call to action acts performed by users as to the products, services and content; provide actions associated with the acts performed by the users; and associate rewards to the acts performed by the users.

In example 9, the computing device of example 8, wherein the particular entities comprise multiple providers providing a plurality of products, services and/or content.

In example 10, the computing device of example 8, wherein the particular entities are identified by the products, services and/or content that they provide.

In example 11, the computing device of example 8, wherein the particular entities are identified when a call to action is performed as related to products, services and/or content of the particular entities.

In example 12, the computing device of example 8, wherein the multiple users are identified individually by unique user identifiers.

In example 13, the computing device of example 8, wherein the multiple users are rewarded when a transaction is performed using one or more of the call to action acts.

Example 14 is non-transitory computer readable medium that comprises program instructions that causes a computer to perform the method comprising: selecting products, services and/or content from one or more locations; determining a user action related to the products, services and/or content; associating the user action related to the products, services and/or content; andrewarding the user action with call to action act.

In example 15, the non-transitory computer readable medium of example 14, wherein the products, services and/or content are associated with one or more entities.

In example 16, the non-transitory computer readable medium of example 15, wherein the method further comprises crediting particular entities of the one or more entities.

In example 17, the non-transitory computer readable medium of example 14, wherein the user action identifies a particular user.

In example 18, the non-transitory computer readable medium of example 14, wherein the rewarding the user action is part of an automated user fulfillment.

In example 19, the non-transitory computer readable medium of example 14, wherein the rewarding the user action is selected by users

In example 20, the non-transitory computer readable medium of example 14, wherein the rewarding is one or more of: downloading, discounting, or giving away a product, service, or content.

What is claimed is:

1. A content management system comprising:
one or more servers accessing multiple providers comprising a plurality of products, services and/or content, and interfacing with multiple users, wherein the one or more servers comprise:
call to action modules that associate user action to the multiple providers and the products, services and/or content;
a module that associates the multiple users with actions as performed through the call to action modules; and
a automatic user fulfillment module that relates rewards to actions performed.

2. The content management system of claim 1. wherein the multiple providers comprise multiple parties providing the plurality of products, services and/or content, wherein particular entities provide particular products, services and/or content.

3. The content management system of claim 2, wherein the call to action modules identify actions associated with the particular entities of the multiple entities.

4. The content management system of claim 2, wherein the particular entities are identified by the products, services and/or content that they provide.

5. The content management system of claim 2, wherein the particular entities are identified when a call to action is performed as related to products, services and/or content of the particular entities.

6. The content management system of claim 1, wherein the multiple users are identified individually by unique user identifiers.

7. The content management system of claim 1, wherein the multiple users are rewarded when a transaction is performed using one or more of the call to action modules.

8. A computing device supporting a content management system comprising:
one or more processors; and
memory accessed by the one or more processors configured to:
associate a products, services and content to particular entities;
associate call to action acts performed by users as to the products, services and content;
provide actions associated with the acts performed by the users; and
associate rewards to the acts performed by the users.

9. The computing device of claim 8, wherein the particular entities comprise multiple providers providing a plurality of products, services and/or content.

10. The computing device of claim 8, wherein the particular entities are identified by the products, services and/or content that they provide.

11. The computing device of claim 8, wherein the particular entities are identified when a call to action is performed as related to products, services and/or content of the particular entities.

12. The computing device of claim 8, wherein the multiple users are identified individually by unique user identifiers.

13. The computing device of claim 8, wherein the multiple users are rewarded when a transaction is performed using one or more of the call to action acts.

14. Non-transitory computer readable medium that comprises program instructions that causes a computer to perform the method comprising:
selecting products, services and/or content from one or more locations;
determining a user action related to the products, services and/or content;
associating the user action related to the products, services and/or content; and
rewarding the user action.

15. The non-transitory computer readable medium of claim 14, wherein the products, services and/or content are associated with one or more entities.

16. The non-transitory computer readable medium of claim 15, wherein the method further comprises crediting particular entities of the one or more entities.

17. The non-transitory computer readable medium of claim 14, wherein the user action identifies a particular user.

18. The non-transitory computer readable medium of claim 14, wherein the rewarding the user action is part of an automated user fulfillment.

19. The non-transitory computer readable medium of claim 14, wherein the rewarding the user action is selected by users.

20. The non-transitory computer readable medium of claim 14, wherein the rewarding is one or more of: downloading, discounting, or giving away a product, service, or content.
